(19) United States
(12) Patent Application Publication
(10) Pub. No.: US 2004/0185832 A1
(43) Pub. Date: Sep. 23, 2004

(54) Messaging via a multimedia messaging service (mms)

(76) Inventors: Ralf Prenzel, Salzgitter (DE); Andreas Schmidt, Braunschweig (DE); Markus Trauberg, Velchede (DE)

Correspondence Address: BELL, BOYD & LLOYD, LLC, P. O. BOX 1135, CHICAGO, IL, 60690-1135, US

(21) Appl. No.: 10/474,630

(22) PCT Filed: Feb. 20, 2002
(86) PCT No.: PCT/DE02/00631

(30) Foreign Application Priority Data
Apr. 10, 2001 (DE) 101 17 895.6

(51) Int. Cl. H04Q 7/20

(52) U.S. Cl. 455/412.1; 455/412.2; 455/414.1

(57) ABSTRACT

The recipient of multimedia messages is informed of the importance of said messages before they are received. The recipient is correspondingly informed of the available message in a data support device. A form of identification concerning the importance of the available message is sent to the recipient with said notification. The recipient can download the multimedia message straight away or later onto the terminal based on the basis of said importance related ID.

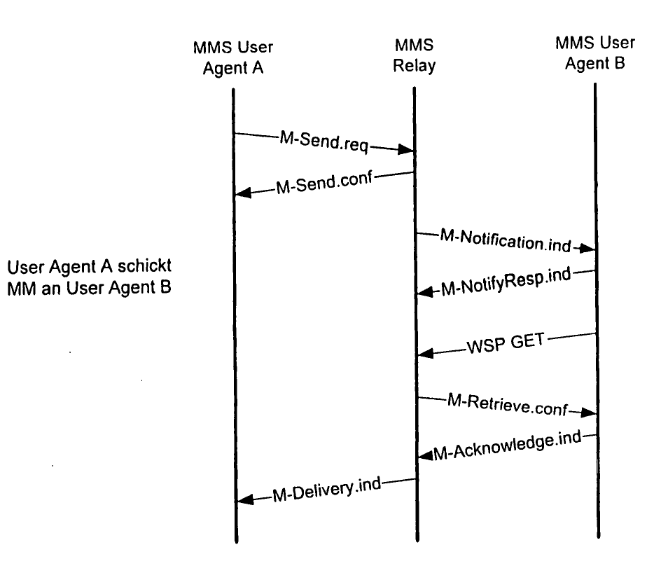

### PRIOR ART

The present invention relates to a device for transmitting a message with a data support device for providing the message and a transmission device for sending a notification to a recipient if a message for the recipient is available in the data support device, and for sending the message to the recipient either as requested by the recipient or without condition. In addition, the present invention relates to a device for receiving and providing a message with a reception device for receiving the message from a relay station and for receiving a notification that indicates that a message for the recipient is available in the relay station. The present invention also relates to corresponding transmission and reception methods.

In addition to voice telephony, the GSM mobile radio system (GSM—Global System for Mobile Communications) offers facilities for sending and receiving text messages up to 160 characters in length. This service is called the Short Message Service (SMS).

For the UTMS third generation mobile radio system (Universal Mobile Telecommunication System) a multimedia-compatible variant of a mobile message service, known as the Multimedia Messaging Service (MMS) is currently being standardized. The relevant standardization protocols are: 3G TS 23.140 version 4.1.0, Release 4; Third Generation Partnership Project; Technical Specification Group Terminals; Multimedia Messaging Service (MMS); Functional Description; Stage 2, WAP-209-MMSEncapsulation, Release 2000; Wireless Application Protocol; WAP Multimedia Messaging Service; Message Encapsulation; MMS Proposed SCD 1.0 and 3G TS 22.140 v. 4.0.1 (July 2000): 3^{rd} Generation Partnership Project; Technical Specification Group Services and System Aspects; Service Aspects; Stage 1 Multimedia Messaging Service.

Messages with a multimedia content are henceforth referred to as MM (multimedia messages) for short to distinguish them from SMS text messages. In contrast to SMS messages, there is no restriction to just text content. With MMS it will also be possible to format text to suit personal tastes and to embed any content in a message. Examples of such content include audio and video, still images, graphics and text.

In accordance with the prior art, MMS can only be implemented via WAP (Wireless Application Protocol). To bridge the air interface between an MMS-compatible terminal and the WAP gateway, the use of the WAP Wireless Session protocols (WSP) is planned in accordance with WAP-209-MMSEncapsulation and WAP-203-WSP. The enclosed drawing presents a transaction flow diagram conforming to the latest state of the art in accordance with WAP-209-MMSEncapsulation in which the exchange of WAP message among the three entities involved, namely MMS User Agent A, MMS Relay and MMS User Agent B, is shown for transmission and reception of an MM. An MMS user agent is taken to be an application on a mobile terminal or on a device connected to a mobile terminal (laptop etc.) which implements MMS functionality. An MMS relay or MMS relay station is a network element operated by the MMS service provider that makes MMS functionality available to the MMS user agents.

Information is transferred between users in the form of messages. A message basically consists of a header and an optional data section (known as the body part) that contains the multimedia objects.

In addition, notifications indicating the statuses of the messages are sent between the technical facilities and users involved in message transfer. For example, M-Notification.ind informs the recipient that a message is available in relay station MMS Relay. Both the messages and the notifications are shown in the drawing as arrows (“User Agent A sends MM to User Agent B”).

Another very widespread system is internet email as described in RFC822: “Standard for the Format of ARPA Internet Text Messages”, Crocker D., August 1982. URL: ftp://ftp.isi.edu/in-notes/rfc822.txt. In principle, internet email offers similar functions to MMS but has been used up to now almost exclusively for fixed network terminals. In contrast to internet email, the MMS includes the prior notification for the recipient about the presence of a deliverable MM in addition to the downloadable message. On receipt of the notification, which is “pushed” to the recipient's terminal, in other words transmitted to the terminal without any initiative from the recipient, the recipient can decide whether to download the message to his or her terminal immediately, later or not at all. This gives the recipient a high degree of flexibility in downloading the message on receipt of the notification.

Also in accordance with prior art, the sender of a message can assign a high priority to the message. This information is coded in the WAP implementation of the MMS in the form of a field in the header of the MM (priority field in accordance with WAP-209-MMSEncapsulation) which is transferred from the sending MMS User Agent A to the MM Relay (in WAP: M-Send.req) and from the MMS Relay to the receiving MMS User Agent B (in WAP: M-Retrieve.conf). The disadvantage here is that the recipient does not receive any information about the priority of the message until the message itself actually arrives.

The object of the present invention is therefore to propose a device and a method for sending and receiving multimedia messages whereby recipients can retrieve information about the priority of an available message without having also to retrieve the message itself.

This object is achieved by a device according to claim 1 and a method according to claim 11 for sending a message. The object is also achieved by a device according to claim 6 and a method according to claim 15 for receiving a message.

Advantageous developments of the invention are given in the subclaims.

Until now, coding of the priority of an MM in the notification (in WAP: M-Notification.ind) has not been defined in the WAP implementation of the MMS. There was therefore no possibility of sending this information to the receiving MMS User Agent B in advance so that the recipient could take the appropriate action.

The invention therefore provides for a means of identifying the priority of the message (MM) in the notification (in WAP: M-Notification.ind) in the Multimedia Messaging Service. The relevant information is preferably encoded in the header of an MM. This also opens up the option of making the behavior of the receiving MMM User Agent B dependent on the MM priority identifier in the notification. There is provision in the MMS for the MM itself to be downloaded to the terminal either immediately on receipt of the notification (immediate retrieval) or at a later date (deferred retrieval). The behavior of the receiving MMM User Agent B is not defined in specifications 3G TS 23.140, WAP-209-MMSEncapsulation and 3G TS 22.140. According to the present invention, the receiving MMM User Agent B can be configured so that an MM is transmitted to the receiving MMM User Agent B either immediately or at a later date at the instigation of the recipient, depending on the priority indicated in the notification.

The present invention is now described in further detail with reference to the attached drawing which shows an MMS transaction flow diagram in the WAP implementation.

The tables show concrete exemplary embodiments, in particular

Table 1 an assignment of binary codes to header field names according to WAP-209-MMSEncapsulation;

Table 2 encoding of the priority field;

Table 3 header fields of the WAP message M-Send.req;

Table 4 header fields of the WAP message M-Notification.ind; and

Table 5 header fields of the WAP message M-Retrieve.conf.

In the following exemplary embodiment of the present invention the proposed option of encoding the priority of an MM in the notification of the receiving MMS User Agent B is demonstrated with the aid of the WAP implementations of the messages. The following sample scenario is assumed: MMS User A sends an MM to recipient MMS User B with text as its content.

The following messages are transferred between the entities.

The MM is identified by the sender in accordance with prior art with high priority in the message shown in the drawing (M-Send.req) by the application MMS User Agent A of MMS User A to MMS Relay.

M-Send.reg (MMS User Agent A→MMS Relay):

X-Mms-Message-Type: m-send.req

X-Mms-Transaction-ID: TRANSACTION-ID#1

X-Mms-Version: 1.0

Date: Fri, 14 Jul. 2000 14:12:19 +0100

From: usera@siemens.de

To: userb@siemens.de

Subject: Photo of lab setup

X-Mms-Priority: High

nEntries: 1

HeadersLen: XX

DataLen: XX

Content-Type: text/plain;

Hello User B,

Please send me the photo of our lab setup. It's urgent.

Regards

User A

The data section of message M-Send.req merely contains a text message in its data section requesting an immediate response that should include a photo.

The header of message M-Send.req has a number of fields, representing a selection from Table 1, in which binary codes are assigned to the field names. As shown in Table 2, the priority field X-Mms-Priority may have the values low, normal or high according to WAP-209-MMSEncapsulation. These values are encoded here as priority values by way of example.

In its most general form, the header of the WAP message M-Send.req has the structure shown in Table 3. Some fields are mandatory and some are optional.

The send request (in WAP: M-Send.req) of MMS User Agent A is acknowledged by MMS Relay with a message (in WAP: M-Send.conf) according to the drawing.

The recipient of the MM, User B, is informed of the new message that is waiting for him by an M-Notification.ind message to MMS User Agent B. The new aspect according to this invention is the information about the priority of the MM (X-Mms-Priority) contained in the notification.

M-Notification.ind (MMS Relay→MMS User Agent B):

X-Mms-Message-Type: m-notification.ind

X-Mms-Transaction-ID: TRANSACTION-ID#2

X-Mms-Version: 1.0

From: usera@siemens.de

X-Mms-Message-Class: Personal

X-Mms-Message-Size: XXX (Attachments+Header)

X-Mms-Expiry: 3600

X-Mms-Content-Location: www.siemens.de/mms-inbox/ABCD.1234

Subject: Photo of lab setup

X-Mms-Priority: High

The general form of this message M-Notification.ind is shown in Table 4. In accordance with this invention, the field X-Mms-Priority of message M-Send.req has been transferred to message M-Notification.ind. The priority of the message is also encoded here in accordance with table 3. The priority can be encoded in two or more values however. The other fields of Table 4 are described in more detail in WAP-209-MMSEncapsulation.

Message M-Notification.ind is transferred from the relay station MMS Relay to the application MMS User Agent B according to the drawing by message M-NotifyResp.ind.

MM downloading is actuated by the command WSP GET.req. The MM is then sent from MMS Relay in message M-Retrieve.conf to MMS User Agent B. On the basis of the information that the MM has a high priority, the recipient MMS User Agent B can be configured so that the MM is downloaded immediately following receipt and evaluation of the notification.

M-Retrieve.conf (MMS Relay→MMS User Agent B):

X-Mms-Message-Type: m-retrieve.conf

X-Mms-Transaction-ID: TRANSACTION-ID#3

X-Mms-Version: 1.0

Date: Fri, 14 Jul. 2000 14:12:19 +0100

From: usera@siemens.de

To: userb@siemens.de

X-Mms-Message-ID: MESSAGE-ID#1

Subject: Photo of lab setup

X-Mms-Priority: High

Content-Type: text/plain;

nEntries: 1

HeadersLen: XX

DataLen: XX

Hello User B,

Please send me the photo of our lab setup. It's urgent.

Regards

User A

Header field X-Mms-Priority is also included in message M-Retrieve.conf, as shown in Table 5. Table 5, which is also taken from WAP-209-MMSEncapsulation, shows the mandatory and optional fields in the message.

In accordance with the drawing, receipt of the message is confirmed by MMS User Agent B by message M-Acknowledge.ind to MMS Relay. MMS Relay in turn confirms receipt of this message to MMS User Agent A by message M-Delivery.ind. Refer to 3G TS 23.140 and WAP-209-MMSEncapsulation.

In accordance with the invention, a method is implemented for indicating the priority of a multimedia message MM in the Multimedia Messaging Service MMS in the notification for the recipient about a particular MM that is ready for delivery. The priority is advantageously encoded in WAP as follows: field name X-Mms-Priority as 0×0 F and field value as low, normal or high. On receiving the notification of the MM, the recipient of the MM can then make the decision on whether the MM is to be transferred to the terminal immediately (immediate retrieval) or later (deferred retrieval) dependent on the specified priority of the MM. Furthermore, when notifications of deliverable MMs arrive the receiving User Agent B can automatically activate immediate or deferred downloading of the MM depending on the specified priority of the MM.

### Tables

TABLE 1
Assignment of binary codes to field names

| | Assigned | Serial | |
|---|---|---|---|
| Name | number | number | Comments |
| BCC | 0x01 | 1 | From |
| Cc | 0x02 | 2 | Table 2 in |
| X-Mms-Content-Location | 0x03 | 3 | WAP-209- |
| | | | MMSEncapsulation |
| Content-Type | 0x04 | 4 | |
| Date | 0x05 | 5 | |
| X-Mms-Delivery- | 0x06 | 6 | |
| Report | | | |
| X-Mms-Delivery-Time | 0x07 | 7 | |
| X-Mms-Expiry | 0x08 | 8 | |
| From | 0x09 | 9 | |
| X-Mms-Message-Class | 0x0A | 10 | |
| Message-ID | 0x0B | 11 | |
| X-Mms-Message-Type | 0x0C | 12 | |
| X-Mms-MMS-Version | 0x0D | 13 | |
| X-Mms-Message-Size | 0x0E | 14 | |
| X-Mms-Priority | 0x0F | 15 | |
| X-Mms-Read-Reply | 0x10 | 16 | |
| X-Mms-Report- | 0x11 | 17 | |
| Allowed | | | |
| X-Mms-Response- | 0x12 | 18 | |
| Status | | | |
| X-Mms-Sender- | 0x13 | 19 | |
| Visibility | | | |
| X-Mms-Status | 0x14 | 20 | |
| Subject | 0x15 | 21 | |
| To | 0x16 | 22 | |
| X-Mms-Transaction- | 0x17 | 23 | |
| Id | | | |
| . | . | . | |
| . | . | . | |
| . | . | . | |

TABLE 2
Coding of the priority field

```
X-Mms-Priority (0x0F):
  Priority-value = Low | Normal | High
  Low = <Octet 128>
  Normal = <Octet 129>
  High = <Octet 130>
```

TABLE 3
M-Send.reg

| Name | Content | Comments |
|---|---|---|
| X-Mms-Message- | Message-type- | Mandatory. |
| Type | value = m- | Specifies the transaction type. |
| | send-req | |
| X-Mms- | Transaction- | Mandatory. |
| Transaction-ID | Id-value | A unique identifier for the |
| | | message. This transaction ID |
| | | identifies only the M-Send.req and |
| | | the appropriate response. |
| X-Mms-MMS- | MMS-version- | Mandatory. |
| Version | value | The MMS version number. |
| | | According to this description |
| | | the version is 1.0. |
| Date | Date-value | Optional. |
| | | Arrival time of the message at the |
| | | MMS server. The MMS server |
| | | creates this field if it is not |
| | | provided by a terminal. |
| From | From-value | Mandatory. |
| | | Address of the message sender. This |
| | | field MUST be present is a message |
| | | addressed to a recipient. This |
| | | field MAY be created by the sending |
| | | client or MAY be inserted at the |
| | | MMS server by the address insertion |
| | | signal. |
| To | To-value | Optional. |
| | | Address of the recipient. |
| | | Any number of address fields |
| | | permitted. |
| Cc | Cc-value | Optional. |
| | | Address of the recipient. |
| | | Any number of address fields |
| | | permitted. |
| Bcc | Bcc-value | Optional. |
| | | Address of the recipient. |
| | | Any number of address fields |
| | | permitted. |
| Subject | Subject-value | Optional. |
| | | Subject of the message. |
| X-Mms-Message- | Message- | Optional. |
| Class | class-value | Class of the message. The value |
| | | Auto indicates a message that is |
| | | automatically generated by the |
| | | client. If the message class is |
| | | Auto the originating terminal |
| | | SHOULD NOT request a delivery |
| | | report or read report. |
| | | If the field is absent the |
| | | recipient interprets the message as |
| | | personal. |
| X-Mms-Expiry | Expiry-value | Optional, default: maximum. |
| | | Duration for which the message is |
| | | stored in the server or time until |
| | | the message is deleted. The field |
| | | has two formats, either absolute |
| | | or interval. |
| X-Mms- | Delivery- | Optional: default: immediate. |
| Delivery-Time | time-value | Time delivery is required. |
| | | Indicates the earliest possible |
| | | delivery of the message to the |
| | | recipient. The field has two |
| | | formats, either absolute or |
| | | interval. |
| X-Mms-Priority | Priority- | Optional: default: normal. |
| | value | Priority of the message for the |
| | | recipient. |
| X-Mms-Content- | Content- | Optional. |
| ID | IDentifier | This field defines the location of |
| | | the MM element. |
| X-Mms-Content- | Content-type- | Optional. |
| Type | value | Specifies the content type of the |
| | | MM element. |
| X-Mms-Content- | Content-size- | Optional. |
| Size | value | Total size of the MM element as an |
| | | octal number. |
| X-Mms-Content- | Content-name | Optional. |
| Name | | Name of the MM element. |
| X-Mms-Content- | Location- | Optional. |
| Related-URI | Value | Defines the location of another MM |
| | | element to which the described MM |
| | | element relates. |
| X-Mms- | External- | Optional. |
| External-Link- | Link-Flag | Indicates whether the MM or one of |
| Flag | | its MM elements contains a link to |
| | | an element outside the entire MM. |
| X-Mms- | External- | Optional. |
| External-Link- | Link-Size | Total size of the connected |
| Size | | external element as an octal |
| | | number. |

TABLE 4
M-Notification.ind

| Name | Content | Comments |
|---|---|---|
| X-Mms-Message- | m- | Mandatory. Specifies the |
| Type | notification- | transaction type. |
| | ind | |
| X-Mms- | A unique | Mandatory. Identifies the message |
| Transaction-ID | identifier | and the subsequent transaction |
| | | which is completed by the following |
| | | M-NotifyResp. |
| X-Mms-MMS- | Version | Mandatory. |
| Version | number | The MMS version number. |
| | | According to this description |
| | | the version is 1.0. |
| From | Sender address | Optional. |
| | | If concealing the address of the |
| | | sender is supported by the |
| | | recipient the MMS server will not |
| | | insert this field in a message |
| | | header. |
| X-Mms-Priority | Priority- | Optional. Default: normal. |
| | value | Priority of the message for the |
| | | recipient. |
| X-Mms-Message- | Message- | Mandatory. |
| Class | Class-Value | Class of the message. |
| X-Mms-Message- | Size of | Mandatory. |
| Size | message | Total size of the message as an |
| | | octal number. |
| X-Mms-Expiry | Expiry-value | Mandatory. |
| | | Duration for which the message is |
| | | available. The field has only one |
| | | format, interval. |
| X-Mms-Content- | Content- | Mandatory. |
| Location | Location- | This field defines the location of |
| | Value | the message. |

TABLE 5
M-Retrieve.conf

| Name | Content | Comments |
|---|---|---|
| X-Mms-Message- | Message-type- | Mandatory. |
| Type | Value = m- | Specifies the message type. |
| | retrieve-conf | |
| X-Mms- | Transaction- | Optional. |
| Transaction-ID | id-value | Identifies either the transaction |
| | | that was started by M-Notification |
| | | without M-NotifyResp or a new |
| | | transaction if later delivery has |
| | | been requested. The new transaction |
| | | ID is optional. |
| X-Mms-MMS- | MMS-version- | Mandatory. |
| Version | value | The MMS version number. In this |
| | | description the version is 1.0. |
| Message-ID | Message-ID- | Mandatory. |
| | value | This is a unique reference assigned |
| | | to the message. This ID MUST |
| | | always be present if the sending |
| | | client requires a read reply. |
| | | The ID enables a client to check |
| | | read reports against previously |
| | | sent messages. |
| Date | Date-value | Optional. |
| | | Send date and time. |
| From | From-value | Mandatory. |
| | | Address of the sender. If |
| | | concealing the address of the |
| | | sender is supported by the |
| | | recipient the MMS server will not |
| | | insert this field in a message |
| | | header. |
| To | To-value | Optional. |
| | | Address of the recipient. |
| | | Any number of address fields |
| | | permitted. |
| Cc | Cc-value | Optional. |
| | | Address of the recipient. |
| | | Any number of address fields |
| | | permitted. |
| Subject | Subject-value | Optional. |
| | | Subject of the message. |
| X-Mms-Message- | Message- | Optional. |
| Class | class-value | Class of the message. If the field |
| | | is absent the recipient interprets |
| | | the message as personal. |
| X-Mms-Priority | Priority- | Optional. Default: normal. |
| | value | Priority of the message. |
| X-Mms- | Delivery- | Optional. Default: no. |
| Delivery- | report-value | Indicates whether the user requires |
| Report | | a delivery report from each |
| | | recipient. |
| X-Mms-read- | Read-reply- | Optional. Default: no. |
| Reply | value | Indicates whether the user requires |
| | | a read report from each recipient |
| | | as a new message. |
| Content-Type | Content-type- | Mandatory. |
| | value | The content type of the message. |

1. Device for transmitting a message with a data support device for providing the message and a transmission device for sending a notification to a recipient if a message for the recipient is available in the data support device, and for sending the message to the recipient either as requested by the recipient or without condition
characterized in that
an identifier indicating the priority of the message can also be delivered by the data storage system and the identifier can be transferred by the transmission equipment with the notification to the recipient.

2. Device according to claim 1, in which the message is a multimedia message (MM).

3. Device according to claim 1 or 2, which is a Multimedia Messaging Service relay station (MMS Relay).

4. Device according to one of the claims 1 to 3, with a coding facility for encoding the priority identifier for a message as one of three levels, low, normal or high.

5. Device according to one of the claims 1 to 4, with an extraction facility for extracting a priority identifier from the header of a message and for writing this identifier into the notification to the recipient.

6. Device for receiving and providing a message with a receiving facility for receiving the message from a relay station (MMS Relay) and for receiving a notification that indicates that a message for the recipient is available in the relay station,
characterized by
a data processing facility with which an identifier for the priority of the message available in the relay station can be read from the notification.

7. Device according to claim 6, with a display facility for displaying the priority of the available message on the basis of the received identifier.

8. Device according to claim 6 or 7, in which the priority can be encoded in two or more levels in the identifier.

9. Device according to claim 8, with a retrieval facility for automatically retrieving the available message from the relay station if the identifier for the priority of the message is in the highest priority level.

10. Device according to one of the claims 6 to 9, in which the data processing facility can extract in addition to the priority identifier at least one further data record from the notification and the data record(s) and the priority identifier can be used as the basis for automatically retrieving the message from the relay station.

11. Method for transferring a message by receiving a message, making the message available in a data storage facility and sending a notification to a recipient that indicates that a message is available for the recipient in the data storage facility,
characterized in that
sending the message also includes sending an identifier for the priority of the message to the recipient.

12. Method according to claim 10, in which the message is a multimedia message (MM).

13. Method according to claim 11 or 12, in which the priority is encoded in at least two levels in the identifier.

14. Method according to one of the claims 11 to 13, in which the identifier for the priority of the message is extracted from the header of the received message and transferred to the notification.

15. Method for receiving a message by receiving a notification from a relay station (MMS Relay) that indicates that the relay station has made a message available,
extracting an identifier for the priority of the message from the notification and retrieving the message from the relay station on the basis of the priority identifier.

16. Method according to claim 15, in which at least two priority levels are encoded in the identifier.

17. Method according to claim 16, in which the message is automatically retrieved if the notification has the highest priority level.

18. Method according to one of the claims 15 to 17, in which at least one further data record in addition to the priority identifier is extracted from the notification and the message is retrieved on the basis of the data record(s) and the priority identifier.
